(19) United States
(12) Patent Application Publication
(10) Pub. No.: US 2009/0315923 A1
(43) Pub. Date: Dec. 24, 2009

(54) ELECTRONIC PAPER PANEL IMAGE DISPLAY METHOD

(76) Inventors: Feng Qiao, Beijing (CN); Pingfen Lin, Beijing (CN); Jingyu Liu, Beijing (CN); Yang Zhou, Beijing (CN); Yuming Fang, Beijing (CN)

Correspondence Address: J.C. Patents, Suite 250, 4 Venture, Irvine, CA, 92618, US

(21) Appl. No.: 12/323,327

(22) Filed: Nov. 25, 2008

(30) Foreign Application Priority Data
Jun. 18, 2008 (CN) 200810115108.X

(51) Int. Cl. G09G 5/02

(52) U.S. Cl. 345/698

(57) ABSTRACT

A display method of images in electronic paper panel includes: set the resolution for display; add a new event which indicates and drives the new image display; trim the new image to fit in with the resolution; compress the image when it needs to be stored, only reserve the mean values of pixels within each column and each row, as the character of the image; compare the next image with the present image and get the correlation coefficient of the two images; according to the correlation coefficient, set a proper display mode; enhance the image based on human visual character, and then display image. This invention extends the application of electronic paper to intelligent operating system areas, and it is easy to be ported to different advanced intelligent operating systems. It can significantly eliminate the ghosting and flicker on the electronic paper panel, and it also reduces the power consumption of the electronic paper systems and reduces the response time for display. This invention introduces a practical method for further application in various areas of the electronic paper.

### CROSS-REFERENCE TO RELATED APPLICATION

This application claims priority benefit of Chinese application No. 200810115108.X, filed on Jun. 18, 2008, the content of which is hereby incorporated by reference in its entirety.

### FIELD OF THE INVENTION

This invention is related to a method of display images on electronic products, which use an intelligent operation system and the electronic paper panel.

### BACKGROUND OF THE INVENTION

The consumption of paper is increasing significantly nowadays. It causes an unprecedented disaster to the environment. So we are trying to find a new material to replace paper, in order to protect the forests and environment. Fortunately a rewritable display screen called electronic paper is invented and are popular in recent years. It is almost as soft and flimsy as paper and able to display images clearly and steadily without power. Electronic paper panel is specially designed for the reading of electronic devices; it provides a higher contrast, a clear display of text and handwriting on display screen, lower power consumption and a light flexibility. It can erase or rewrite display images and used repeatedly, so it saves a lot of paper. As an ideal replace of paper and a good protection of forest resources, the electronic paper uses a special display technique, providing a great convenience in application. The thickness and flexibility of the electronic paper panel is similar to paper, and it can be easily curled and puckered. The electronic paper provides a perfect display quality as good as paper, the image display on the electronic paper panel can be updated whenever it is needed.

The electronic paper has so many advantages that there are a lot of electronic products based on the electronic paper panel in the market. But at the same time there are many limits in these products now. The present electronic paper systems are mostly designed on custom-built Linux or specific operation systems. As a result, the menu of the system is simple, the function is limited and the content is poor. So it is hard to satisfy the demands, which include personal customized menu, intelligence, nice looking and abundant functions. And intelligent operation systems satisfy all these demands, but present electronic paper products have their own faults, like image ghosting, flickers of display screen and so on.

### SUMMARY OF THE INVENTION

One aspect of this invention is to provide a proper display method for the electronic paper based on intelligent operation systems. It can eliminate the ghosting and flicker on the electronic paper panel greatly, when the electronic paper device used intelligent operation systems. This method includes: set the resolution for display image; add a new display event; trim the image; compress the image and store it; compute the correlation coefficient; set the display mode; enhance the image, using human visual character; display the image.

This invention is implemented through the following technologies:

A method of display method on the electronic paper panel, including the following steps:

Set the display resolution to X*Y; add a new event which indicates and drives the new image display; trim the new image to fit in with the resolution; compress the image when it needs to be stored, only reserve the mean values of pixels within each column and each row; compare the next image with the present image and get the correlation coefficient of the two images; according to the correlation coefficient, set a proper display mode; enhance the image based on human visual character and then display it.

The resolution of the above described the electronic paper panel changes from 32*32 pixels to 1920*1920 pixels.

The resolution of the above described images change from 32*32 pixels to 1920*1920 pixels.

The gray degree and color depth of the above described images change from black-white to true color 32-bit.

The method of the above trim the image as follows:

Step 1 trim the new image to fit in with the resolution according to the resolution of the electronic paper panel;

Step 2 trim the image vertically and horizontally as equal as possible;

The algorithm of above compressing image is as follows:

Step 1 compute the mean values of pixels within each odd column or each even column, and then store them in one array.

Step 2 compute the mean values of pixels within each odd row or each even row, and then store them in one array.
The algorithm of above computing the correlation coefficient is as follows:
Step 1: compute the next image and the present image according to the algorithm mentioned above.
Step 2 according to the above result, compute the correlation coefficient horizontally by the means values of rows, and then do it vertically in the same way. The method of the above display mode is as follows:
Step 1: if the correlation coefficient is smaller than the configured threshold, the system would choose the method of display the full picture.
Step 2: if the correlation coefficient is larger than the configured threshold, the system would choose the method of display the partial picture.
The algorithm of above human visual character processing is as follows:
Step 1: consider a certain proportion of pixels in the image as noise spots, and the position of these spots relatively unchangeable.
Step 2 turn these spots into Salt and Pepper Noise.
The electronic paper products mentioned above include all the electronic products using the electronic paper panel.
Compared with current techniques, this invention has apparent advantages and better effect:

When using in electronic paper products based on intelligent operation systems, this invention can apparently reduce image ghosting and flickers on the panel. The method includes: set the display resolution; add a new display event; trim the image; compress image and then store it; compute correlation coefficient; set the display mode; enhance the image based on human visual character; and then display the image. This invention extends the application of electronic paper to intelligent operating system areas, and it is easy to be ported to different advanced intelligent operating systems. It can significantly eliminate the ghosting and flicker on the electronic paper panel, and it also reduces the power consumption of the electronic paper systems and reduces the response time for display. This invention introduces a practical method for further application in various areas of the electronic paper.

### BRIEF DESCRIPTION OF THE DRAWINGS

FIG. 1 is the flow chart of the system in this invention

FIG. 2 is the 6*8 pixels bitmap

FIG. 3 is the mean array of the 6*8 pixels bitmap's column pixels

FIG. 4 is the mean array of the 6*8 pixels bitmap's row pixels

FIG. 5 is an image case before this invention used in the electronic paper panel;

FIG. 6 is an image case of this invention used in the electronic paper panel;

FIG. 7 is an image case before this invention used in the electronic paper panel;

FIG. 8 is a picture case of this invention used in the electronic paper panel;

FIG. 9 is a PDF document case of this invention used in the electronic paper panel;

FIG. 10 is a word document case of this invention used in the electronic paper panel;

FIG. 11 is the control diagram of the electronic paper system of the debug environment in this invention.

### EXAMPLE

The following part combines the figures and case to introduce this invention:

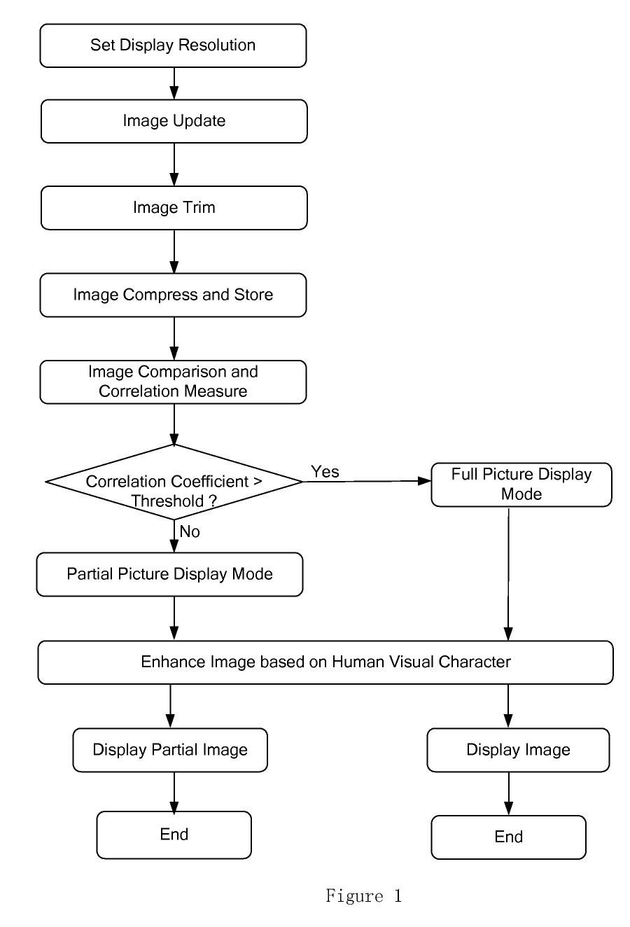

As shown in FIG. 1, a method of display method on the electronic paper panel, including the following steps:

Set the intelligent operation system display resolution; add a new event which indicates and drives new image to display; trim the new image to fit in with the resolution; compress the image when it needs to be stored, only reserve the mean values of pixels within each column and each row as the character of the image; compare the next image with the present image and get the correlation coefficient of these two images; according to the correlation coefficient, set a proper display mode; if the correlation coefficient is smaller than the configured threshold, the system would choose the method of display the full picture, otherwise, the system would choose the method of display the partial picture; enhance the image based on human visual character, and then display it.

In this use case, we choose Windows CE operation system to demonstrate this invention. The resolution of the electronic paper panel is 600*800, including the following steps:

First set the resolution of Windows CE to X*Y(X=608, Y=800), and X and Y must be multiples of 32.

Add a new event to the display driver of Windows CE, this event indicates and drives the new image to display;
Trim the image as follows:
Step 1: According to the resolution of the electronic paper panel (600*800), trim the new image from 608*800 to 600*800;
Step 2: Trim the image vertically and horizontally as equal as possible, cut 4 pixels down both in right and left;
Compress the image when it needs to be stored, only reserve the mean values of pixels in each row and each column.

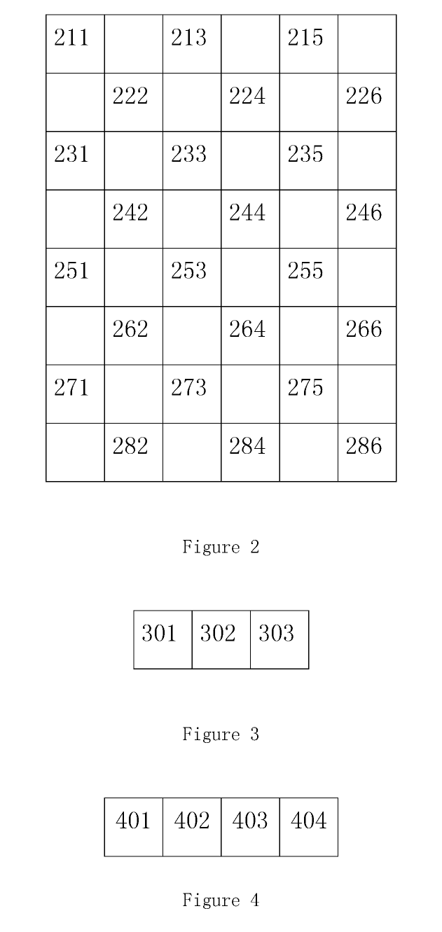

Step 1: compute the mean values of pixels within each odd column and each odd row, and then store them in one array. As shown in FIG. 2, we take a part of the electronic paper panel, which is a bitmap of 6*8 pixels, as an example to explain the compressing algorithm. First choose 4 pixels that are in odd rows from the first odd column. These pixels are 211, 231, 251 and 271 in FIG. 2; Compute the mean value of them; save the mean value into element 301 in the one-dimensional array shown in FIG. 3. And do the same to get the mean value of pixel 213, 233, 253 and 273; store it into element 302, and the mean value of pixel 215, 235, 255 and 275 into element 303, thus all mean values of pixels in columns are stored in a one-dimensional array as shown in FIG. 3.

Step 2: compute the mean values of pixels within each even row and each even column, and then store them in one array. As shown in FIG. 2, we take a part of the electronic paper panel which is a bitmap of 6*8 pixels as an example to explain the compressing algorithm. First choose 3 pixels that are in even columns from the first even row. These pixels are 222, 224 and 226 in FIG. 2; compute the mean value of them; save the mean value into element 401 in the one-dimensional array shown in FIG. 4. Do the same to get the mean value of pixel 242, 244 and 246 and store it into element 402, and then store the mean value of pixel 262, 264 and 266 into element 403, final store the mean value of pixel 282, 284 and 286 into element 404, so all mean values of pixels in rows are stored in a one-dimensional array as shown in FIG. 4.

Compute the correlation coefficient of these two images.
Step 1: compress the image when it needs to be stored, according to the algorithm mentioned above.
Step 2: compute the correlation coefficient vertically using the mean values of rows, and do horizontally in the same way.
According to the correlation coefficient, set the display mode.
Step 1: if the correlation coefficient is smaller than the configured threshold, the system would choose the method of updating the full picture.
Step 2: if the correlation coefficient is larger than the configured threshold, the system would choose the method of updating the partial picture.
Enhance the image based on human visual character.
Step 1: consider a certain proportion of pixels in the image as noise spots and the position of these spots relatively unchangeable.
Step 2: turn these spots into Salt and Pepper Noise.
After the process above, send the image data to memory in the controller of the electronic paper panel, and then display the image.

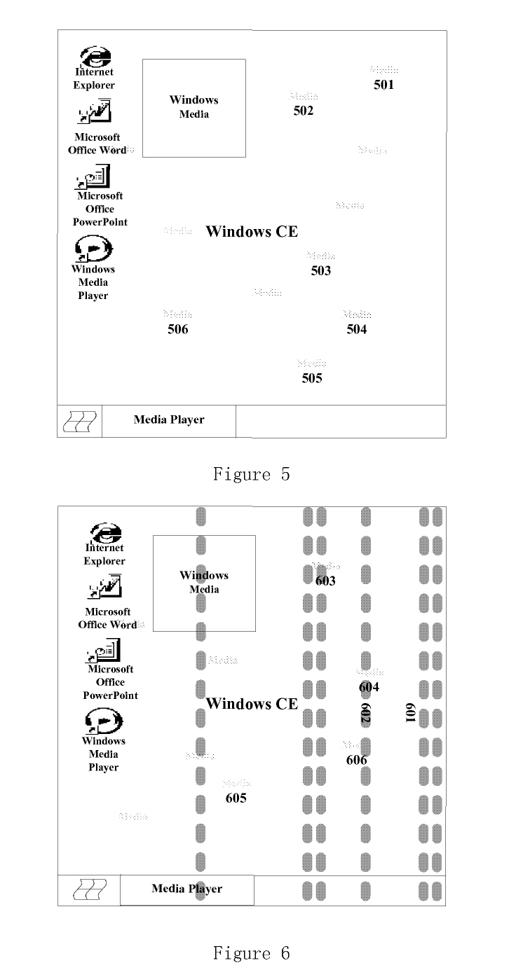

As shown in FIG. 5, when the Media Player is opened in Windows CE operation system ghosting appears on six positions, where they are labeled as 501, 502, 503, 504, 505 and 506. After our invention is used, the display effect is improved as shown in FIG. 6. There are watermarks at spot 601, 602, 603, 604, 605 and 606, and then the ghosting is eliminated by using these watermarks.

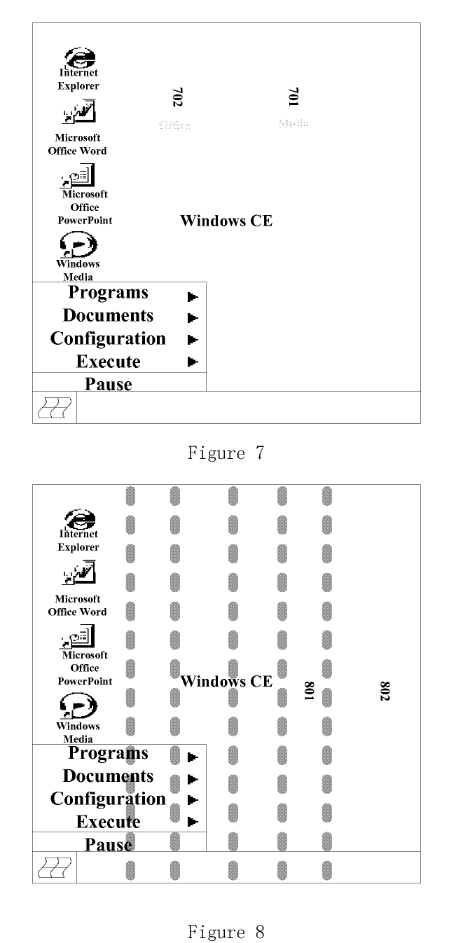

As shown in FIG. 7, when the Start menu in Windows CE is clicked, ghosting appears on spot 701 and 702. After the invention is used, the display effect is improved as shown in FIG. 8. There are watermarks at spot 801, 802, and then the ghosting is eliminated by using these watermarks.

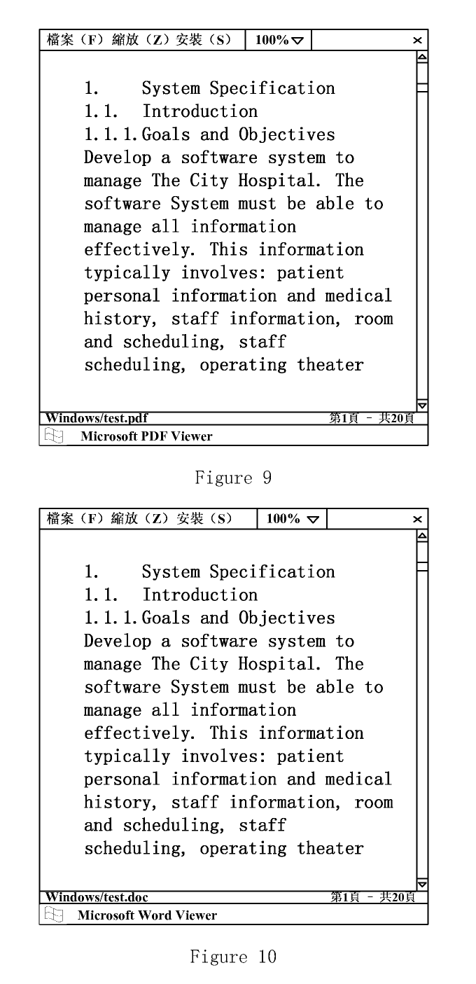

When the invention is used in the electronic paper device for testing, the display effect of a text, which is opened by Microsoft PDF Reader, is shown in FIG. 9. The display effect of a text, which is opened by Microsoft Word Reader, is shown in FIG. 10.

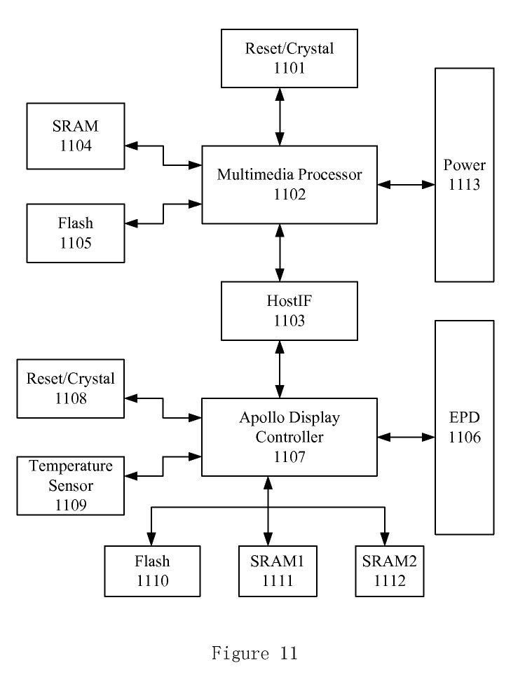

The block diagram of the electronic paper system debug environment is shown in FIG. 11. At first multimedia processor 1102 runs Windows CE operation system in flash memory 1105, and then it copies operation system into SDRAM 1104. Reset circuit and crystal 1101, power 1113 and flash memory 1105 are connected to multimedia processor 1102 separately. It continues running, Windows CE operation system sets display controller 1107 through host Interface 1103. Reset circuit and crystal 1108 and temperature sensor 1109 are connected to display controller 1107 separately. Electronic paper display controller reads data and parameters from flash memory 1110, SRAM (1)1111 and SRAM (2)1112 according to Windows CE configure. Then it controls the electronic paper panel to display image.

There is a point that the order of the above steps could be changed. Thus, this invention does not limit the order of the above steps, even when the order of the above order is changed, it would not effect the integrated operation of this invention. In addition, the use cases of this invention are demonstrative and the invention is not limited in these cases. Therefore, this invention will not be limited in the above described cases. Other methods created by researchers and engineers using this invention are protected in protected fields of this invention.

1. A method of display images on an electronic paper panel comprising:
setting a resolution for display image;
adding a new event, wherein the new event indicates and drives new image display;
trimming the new image to suit to the resolution;
compressing the image when it needs to be stored, only reserving the mean values of pixels within each column and each row, as the character of this image;
comparing next image with a present image and getting a correlation coefficient of these two images;
according to the correlation coefficient, setting a proper display mode;
enhancing the image based on human visual character, and then displaying the image.

2. The method of display images according to claim 1, wherein a resolution of the electronic paper panel is from 32*32 pixels to 1920*1920 pixels.

3. The method of display images according to claim 1, wherein a resolution of the images of the electronic paper is from 32*32 pixels to 1920*1920 pixels.

4. The method of display images according to claim 1, wherein a gray degree and a color depth of the images is in the range from black-white to true color 32-bit.

5. The method of display images according to claim 1, further comprising customizing the image as follow:
Step 1: according to the resolution of the electronic paper, customizing the new image to fit in with the resolution;
Step 2: trimming the image vertically and horizontally as equal as possible.

6. The method of display images according to claim 1, further comprising compressing the image when it needs to be stored as follows:
Step 1: computing the mean values of pixels within each odd column or each even column, and then storing them in one array;
Step 2: computing the mean values of pixels within each odd line or each even line, and then storing them in one array.

7. The method of display images according to claim 6, further comprising computing the correlation coefficient of two images as follows:
Step 1: processing the present image and the next image;
Step 2: according to the results above Step 1, computing the correlation coefficient vertically using the means values of rows, and computing the correlation coefficient horizontally using the means values of columns.

8. The method of display images according to claim 1, further comprising setting the display mode as follows:
Step 1: if the correlation coefficient is smaller than a configured threshold, the system would choose the method of display a full picture.
Step 2: if the correlation coefficient is larger than the configured threshold, the system would choose the method of display a partial picture.

9. The method of display images according to claim 1, wherein the process based on human visual character is as follows:
Step 1 considering a certain proportion of pixels in the image as noise spots, and the position of these spots relatively unchangeable;
Step 2 turning these spots into Salt and Pepper Noise.

10. The method of display images according to claim 1, wherein the electronic paper products include all the electronic products using electronic paper panel.

11. The method of display images according to claim 1, further comprising computing the correlation coefficient of two images as follows:
Step 1: compressing the image when it needs to be stored as follows:
computing the mean values of pixels within each odd column or each even column, and then storing them in one array;
computing the mean values of pixels within each odd line or each even line, and then storing them in one array; and
processing the present image and the next image;
Step 2: according to the results above Step 1, computing the correlation coefficient vertically using the means values of rows, and computing the correlation coefficient horizontally using the means values of columns.

12. The method of display images according to claim 7, further comprising setting the display mode as follows:
Step 1: if the correlation coefficient is smaller than a configured threshold, the system would choose the method of display a full picture;
Step 2: if the correlation coefficient is larger than the configured threshold, the system would choose the method of display a partial picture.
